(19) United States
(12) Patent Application Publication
(10) Pub. No.: US 2022/0353501 A1
(43) Pub. Date: Nov. 3, 2022

(54) IMAGE ENCODING METHOD, IMAGE ENCODING APPARATUS, IMAGE DECODING METHOD, AND IMAGE DECODING APPARATUS

(71) Applicant: Maxell, Ltd., Kyoto (JP)

(72) Inventors: Tomokazu MURAKAMI, Tokyo (JP); Takuya SHIMIZU, Kyoto (JP)

(73) Assignee: Maxell, Ltd., Kyoto (JP)

(21) Appl. No.: 17/764,538

(22) PCT Filed: Sep. 24, 2020
(86) PCT No.: PCT/JP2020/035955

§ 371 Date: Mar. 29, 2022

(30) Foreign Application Priority Data
Sep. 30, 2019 (JP) 2019-178614

(51) Int. Cl. H04N 19/119; H04N 19/105; H04N 19/136; H04N 19/176

(52) U.S. Cl. CPC H04N 19/119; H04N 19/105; H04N 19/136; H04N 19/176

(57) ABSTRACT

The present invention provides a more suitable image encoding technique and image decoding technique. In a block division method in image encoding, if a plurality of description formats are present for the same block division state, a division type, a division direction and a division depth are used as a division pattern to select a block division method. In this manner, adaptive and efficient compression of a video image can be performed.

### TECHNICAL FIELD

The present invention relates to an image encoding method and an image encoding apparatus for encoding an image, and an image decoding method and an image decoding apparatus for decoding encoded image data.

### BACKGROUND ART

H.264/AVC (Advanced Video Coding), H.265/HEVC (High Efficiency Video Coding) standards and the like have been developed as means for recording and transmitting image and audio information as digital data. ISO/IEC MPEG and ITU-T VCEG are also studying a next-generation scheme called VVC (Versatile Video Coding) that achieves a compression ratio that exceeds those of the above (see Non-Patent Document 1).

As one of the candidates for the VVC technique, a block division scheme that combines a plurality of tree structures has been proposed. In this scheme, a block division method is controlled by a tree structure such as a quadtree, a ternary tree and a binary tree. Combining the plurality of tree structures allows a block to be divided into blocks having sizes and shapes that match characteristics of the image, and thus, it is possible to enhance encoding efficiency.

### RELATED ART DOCUMENTS

### Non-Patent Documents

Non-Patent Document 1: Xiaozhong Xu and Shan Liu, “Recent advances in video coding beyond the HEVC standard”. SIP (2019), Volume 8.

### SUMMARY OF THE INVENTION

### Problems to be Solved by the Invention

However, the currently proposed method allows expressions by a plurality of tree structures for the same block division method, whereby a problem arises in which the encoding amount for defining the block division method would increase. In addition, there is a problem in which there are no means for uniquely determining the block division method that allows the plurality of expressions.

The present invention has been conceived in light of the above-described problems, and the object of the present invention is to provide a more suitable image encoding and decoding technique.

### Means for Solving the Problems

In order to achieve the above-described object, an embodiment of the present invention may be configured such that, for example, if a plurality of description formats are present for the same block division state in the block division method in image encoding, a division type, a division direction and a division depth are used as a division pattern to select a block division method. In this manner, adaptive and efficient compression of a video image can be performed.

### Effects of the Invention

According to the present invention, it is possible to provide a more suitable image encoding technique and image decoding technique.

### BRIEF DESCRIPTION OF THE DRAWINGS

FIG. 1 is an explanatory drawing showing an example of an image encoding apparatus according to a first example of the present invention;

FIG. 2 is an explanatory drawing showing an example of an image decoding apparatus according to a second example of the present invention;

FIG. 3 is an explanatory drawing showing an example of an image encoding method according to a first example of the present invention;

FIG. 4 is an explanatory drawing showing an example of an image decoding method according to a second example of the present invention;

FIG. 5 is an explanatory drawing showing an example of a data recording medium according to a third example of the present invention;

FIG. 6 is an explanatory drawing showing details of an example of the image encoding apparatus according to the first example of the present invention;

FIG. 7 is an explanatory drawing showing details of an example of the image decoding apparatus according to the second example of the present invention;

FIG. 8 is an explanatory drawing showing details of an example of the image encoding method according to the first example of the present invention;

FIG. 9 is an explanatory drawing showing details of an example of the image decoding method according to the second example of the present invention; and

FIG. 10 is an explanatory drawing showing a block division method according to an example of the present invention.

### DETAILED DESCRIPTION OF PREFERRED EMODIMENTS

Hereinafter, examples of the present invention will be described with reference to the drawings.

In addition, in each of the drawings, components denoted by the same reference sign are considered to have the same function.

The expression “0 vec” or “0 vector” as used herein and in each of the drawings indicates a vector in which a value of each component is zero, or indicates converting or setting to such a vector.

In addition, the expression “reference unavailable” as used herein and in each of the drawings indicates that block information cannot be obtained because a position of the block is outside a screen range or the like. The expression “reference available” indicates that the block information can be obtained. The block information includes information such as a pixel value, a vector, a reference frame number, and/or a prediction mode.

In addition, the expression “residual component” as used herein and in each of the drawings also includes the same meaning as “prediction error”.

In addition, the expression “region” as used herein and in each of the drawings also includes the same meaning as “image”.

In addition, the expression “transmitted with a flag” as used herein and in each of the drawings also includes the meaning of “is included in the flag and transmitted”.

### First Example

First, a first example of the present invention will be described with reference to the drawings.

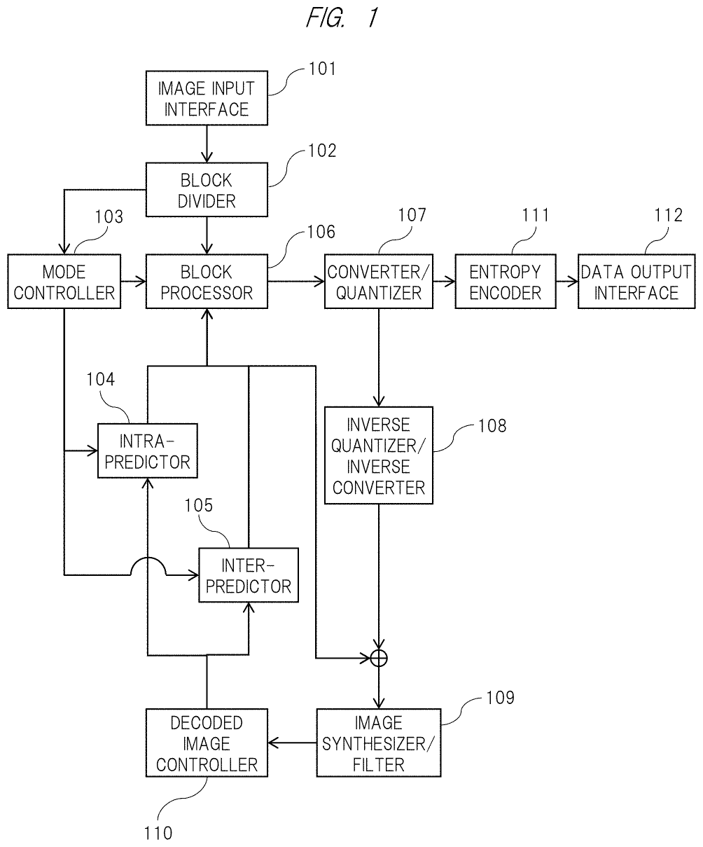

FIG. 1 shows an example of a block diagram of an image encoding apparatus according to a first example of the present invention.

The image encoding apparatus comprises, for example, an image input interface 101, a block divider 102, a mode controller 103, an intra-predictor 104, an inter-predictor 105, a block processor 106, a converter/quantizer 107, an inverse quantizer/inverse converter 108, an image synthesizer/filter 109, a decoded image controller 110, an entropy encoder 111, and a data output interface 112.

Hereinafter, an operation of each component of the image encoding apparatus will be described in detail.

Note that the operation of each component of the image encoding apparatus may be, for example, an autonomous operation of each component as described below. In addition, the operation may be achieved by, for example, cooperating with a controller or software stored in a memory.

First, the image input interface 101 obtains and inputs an original image to be encoded. Next, the block divider 102 divides the input original image into blocks having a certain size called CTUs (Coding Tree Units), and further analyzes the input image to divide each CTU into more detailed blocks according to its characteristics. These blocks which are encoding units are called CUs (Coding Units). The division from CTUs into CUs is controlled by a tree structure such as a quadtree, a ternary tree, and a binary tree. An interior of the CU may be further divided into sub-blocks for prediction or TUs (Transform Units) for frequency conversion, quantization and the like. A new block division scheme added by the present example will be described below in comparison with the conventional block division method.

The mode controller 103 controls a mode that determines an encoding method of each CU. An encoding process is performed using a plurality of intra-prediction and inter-prediction schemes, and the most efficient mode for encoding the CU is determined. The most efficient mode is the mode that can reduce an encoding error the most with respect to a certain encoding amount. There may be more than one optimal mode, and the mode may be selected appropriately according to a current situation. The efficient mode is determined by combining a prediction process of a plurality of modes by the intra-predictor 104 and the inter-predictor 105, a measurement of the encoding amount of a residual component and various flags using another processor, and a prediction of a playback image error at the time of decoding. Generally, the mode is determined for each CU. However, the CU may be divided into sub-blocks, and the mode may be determined for each sub-block.

General methods of predicting the block-to-be-encoded (CU or sub-block) include intra-prediction (intra-frame prediction) and inter-prediction (inter-frame prediction). These are respectively performed by the intra-predictor 104 and the inter-predictor 105. Intra-prediction uses information on the same frame encoded before the block-to-be-encoded, and inter-prediction uses information on the frame encoded before the frame-to-be-encoded and earlier or later in terms of playback time. Here, only one of the intra-predictor 104 and the inter-predictor 105 is described for the sake of explanation. However, they may be provided for each encoding mode and each frame.

The intra-predictor 104 performs an intra-screen prediction process. Note that, in the “prediction process”, a predictive image is generated. The intra-screen prediction process predicts pixels of the block-to-be-encoded using information on the same frame encoded before the block-to-be-encoded. The intra-prediction includes directional prediction, matrix prediction, cross-component prediction, multi-line prediction, intra-screen block copy, and the like. In transmission of the intra-prediction mode, estimation of the most suitable mode or the like among the intra-prediction modes of the encoded block is performed.

The inter-predictor 105 performs an inter-screen prediction process. Note that, in the “prediction process”, a predictive image is generated. The inter-screen prediction process predicts pixels of the block-to-be-encoded using information on the frame encoded before the frame-to-be-encoded and earlier or later in terms of playback time. The inter-prediction includes motion compensation prediction, merge mode prediction, prediction by affine transformation, prediction by triangular block division, prediction by intra-inter combination, optical flow prediction, prediction by decoder-side motion prediction, and the like.

For each block-to-be-encoded, the block processor 106 takes a difference between the predictive image generated by the intra-predictor 104 using intra-prediction, or the predictive image generated by the inter-predictor 105 using inter-prediction, and the original image of the block-to-be-encoded obtained from the block divider 102, and calculates and outputs the residual component.

The converter/quantizer 107 performs frequency conversion and quantization processes on the residual component input from the block processor 106, and outputs a coefficient sequence. The frequency conversion may be performed by using DCT (Discrete Cosine Transform), DST (Discrete Sine Transform), a transformed version of these so as to be processed by an integer operation, or the like. The coefficient sequence is sent to both a process for restoring the image to create a decoded image to be used for prediction, and a process for outputting data. The conversion and quantization may be skipped by specifying the mode.

The inverse quantizer/inverse converter 108 performs inverse quantization and inverse conversion to create a decoded image to be used for predicting the coefficient sequence obtained from the converter/quantizer 107, and outputs the restored residual component. The inverse quantization and inverse conversion may be performed by a process in the reverse direction that corresponds to quantization and conversion by the respective converter and quantizer. The inverse quantization and inverse conversion may be skipped by specifying the mode.

The image synthesizer/filter 109 combines the residual component restored by the inverse quantizer/inverse converter 108 and the predictive image generated by the intra-predictor 104 using intra-prediction, or the predictive image generated by the inter-predictor 105 using inter-prediction, further performs processes such as loop filtering, and generates a decoded image.

The decoded image controller 110 retains the decoded image and controls the image to be referenced for intra-prediction and inter-prediction, mode information, and the like.

The entropy encoder 111 performs an entropy encoding process on mode information and coefficient sequence information, and outputs them as bit strings. A scheme such as a CABAC (Context Adaptive Binary Arithmetic Code) may be used as an entropy encoding scheme. A variable-length code and a fixed-length code may be combined and used. Context may be determined by referring to a defined table.

The data output interface 112 outputs the encoded data to a recording medium or a transmission path.

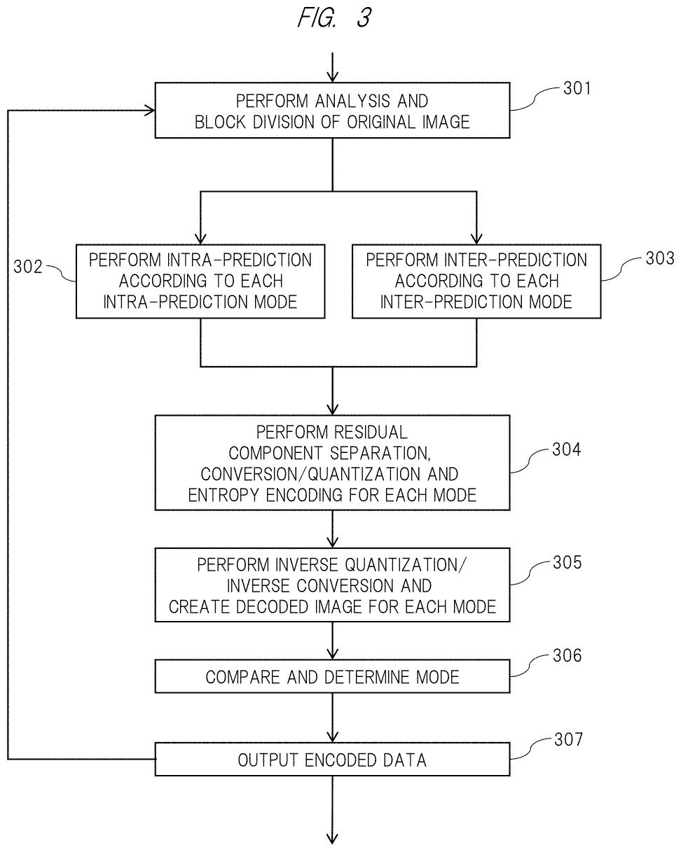

Next, a flow of the encoding method in the image encoding apparatus according to the first example of the present invention will be described with reference to FIG. 3.

First, in step 301, the original image to be encoded is input, an image content is analyzed, a division method is determined, and the image content is divided into blocks. Analysis of the image content may be performed on the entire image, or may be performed on a combination of a plurality of frames, or may be performed on each block unit such as a slice, a tile, a brick, or a CTU into which the image is divided. In block division, the block is generally divided into CTUs having a certain size, which are then divided into CUs according to a tree structure. The new block division scheme added by the present example will be described below in comparison with the conventional block division method.

Next, in step 302, intra-prediction is performed for the block-to-be-encoded of the original image obtained in step 301. The intra-prediction mode is as described above. Prediction is performed for a plurality of modes according to each intra-prediction mode.

Next, in step 303, inter-prediction is performed for the block-to-be-encoded of the original image obtained in step 301. The inter-prediction mode is as described above. Prediction is performed for a plurality of modes according to each inter-prediction mode.

Next, in step 304, for each mode, the residual components are separated for pixels of the intra-predicted and inter-predicted block-to-be-encoded, and conversion, quantization and entropy encoding processes are performed on the residual components to calculate the encoded data.

Next, in step 305, for each mode, inverse quantization and inverse conversion processes are performed, and the residual component and the predictive image are combined to create a decoded image. The decoded image is controlled together with various encoded data and the predicted data for intra-prediction and inter-prediction, and is used for predicting other blocks-to-be-encoded.

Next, in step 306, each mode is compared, and a mode that can be encoded most efficiently is determined. The modes include the intra-prediction mode, the inter-prediction mode and the like, and are collectively referred to as the encoding mode. The mode selection method is as described above.

In step 307, the encoded data of the block-to-be-encoded is output according to the determined encoding mode. The above-described encoding process for each block-to-be-encoded is repeated for the entire image, and the image is encoded.

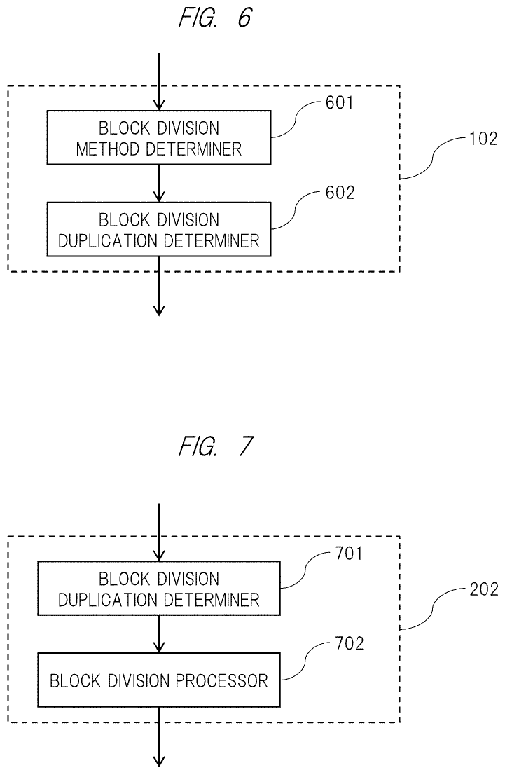

Next, the block division method according to the present example will be described with reference to FIG. 6. Here, a portion of the operation of the block divider 102 will be described in detail.

A block division method determiner 601 analyzes features of the image, adjusts the size and position of the block to allow efficient encoding, and determines the block division method.

A block division duplication determiner 602 determines whether or not the determined block division method allows a plurality of expression formats, and if the plurality of expression formats are possible, the determiner allows only one expression and prohibits the others, or ranks by priority of processing and selects the division method. Methods of determining duplication and performing ranking by priority will be described below.

Hereinafter, the block division method according to the present example will be described with reference to FIG. 8. Here, a portion of step 301 in which block division is performed will be described in detail.

In step 801, the size and position of the block is adjusted and the block division method is determined such that characteristics of the image can be analyzed and efficient encoding can be performed.

In step 802, it is determined whether or not the determined block division method allows the plurality of expression formats, and if the plurality of expression formats are possible, only one expression is allowed and the others are prohibited, or ranking by priority of processing is performed and the division method is selected. Methods of determining duplication and performing ranking by priority will be described below.

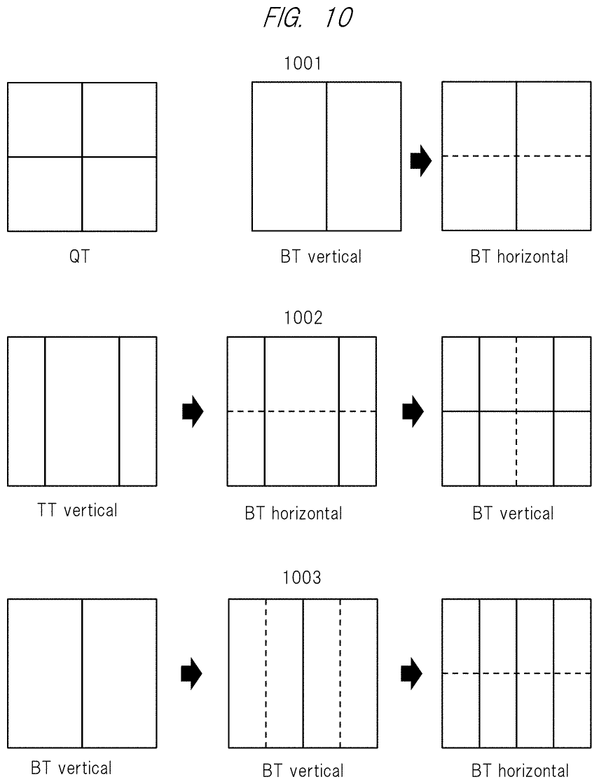

Hereinafter, the block division method that allows the plurality of expression formats will be described with reference to FIG. 10. It is assumed that the block division method includes OT division in which division by a quadtree is performed, TT division in which division by a ternary tree is performed, and BT division in which division by a binary tree is performed. TT division and BT division include divisions in horizontal and vertical directions.

For example, duplication occurs when the block is vertically divided in TT and then the center block is vertically divided in BT, and when the block is vertically divided in BT and then each block is vertically divided again in BT.

In addition, as denoted by reference sign 1001, results of block division are the same when OT division is performed, and when the block is vertically divided in BT and then each block is horizontally divided in BT, or when the block is horizontally divided in BT and then each block is vertically divided in BT, whereby the expression format is duplicated.

In addition, duplication occurs in patterns such as those denoted by reference signs 1002 and 1003. In 1002, the block is vertically divided in TT, each block is horizontally divided in BT, and then the block in the center of each of the upper and lower block groups is vertically divided in BT. In 1003, the block is vertically divided in BT, each block is vertically divided again in BT, and then each block is horizontally divided in BT.

The above-described examples are not the only block division methods that allow the plurality of expression formats.

When duplication occurs in the above-described manner, duplication can be eliminated by allowing only one expression format and prohibiting the other expression formats. One method of prohibiting the expression formats is to check whether or not such a division method is allowed to be performed when block division is performed.

For example, by prohibiting the case where the block is vertically divided in TT and then the center block is vertically divided in BT, it is possible to avoid duplication with the case where the block is vertically divided in BT and then each block is vertically divided again in BT. In this case, if the division method one level above the block of interest is TT, it is sufficient to prohibit division in the same direction as that of the block one level above when dividing the center block (second in processing order).

However, this method of only checking division of one level above or only looking at an upper node of the block of interest does not eliminate other duplications. Therefore, in the present example, information on division patterns of a plurality of tree layers is used as a method to check whether or not the block division can be performed.

Information on the division pattern includes the division type (QT, TT or BT), the division direction (horizontal or vertical), and a division depth indicating how many times each division was performed (including a case where TT and BT are counted together as a multitree (MT)). Information on the plurality of tree layers includes the division pattern of the current block of interest, the division pattern of an upper tree level (parent node) of that block, the division pattern of the block adjacent to that block, and the division pattern of the block in the same tree layer as that block. This includes information on the location of the block of interest.

For example, if the block is vertically divided in BT, it is sufficient to prohibit a subsequent horizontal division in BT to avoid duplication as shown in 1001. In this case, if the division pattern one level above the block of interest is BT, both blocks are prohibited from being divided in a direction opposite to the division direction of the block one level above. In this case, the division pattern to be checked would be the parent node and the node of the adjacent block, or the node of the block in the same layer.

Other methods of eliminating duplication include a method of ranking the division type or the division direction by priority and prohibiting processing in the reverse order.

For example, by ranking QT, TT and BT by priority in this order, OT cannot be performed again after QT and TT or BT are performed. Alternatively, TT cannot be performed again after TT or BT are performed. For example, by ranking the horizontal direction and the vertical direction by priority in this order, horizontal division cannot be performed again after horizontal division and vertical division are performed. However, it is possible to provide conditions such as allowing division to be performed after the division type is changed or allowing not all blocks to be divided. It is needless to say that these conditions may be combined and then ranked by priority.

In addition, another method of eliminating duplication includes a method of prohibiting all blocks divided in a certain direction in BT or TT to be divided in the other direction. There is also a method in which this can be combined with the above-described ranking by priority, and in which division may be performed in a case where BT or TT is performed for the first time (first division depth in MT) while in other cases, all blocks in the same layer are prohibited from being divided in the same manner.

For example, the cases of 1002 and 1003 would be the same as the case in which the block is divided in QT and then all blocks are vertically divided in BT. However, adding the above-described conditions allows the cases of 1002 and 1003 to be eliminated, and thus, the division method can be uniquely defined.

As described above, the encoding process in the present example is performed.

According to the image encoding apparatus and the image encoding method in the above-described first example, it is possible to uniquely define the block division method while achieving various division methods, and thus, it is possible to achieve the image encoding apparatus and the image encoding method with a higher compression efficiency than that of an existing scheme.

In addition, the image encoding apparatus and the image encoding method according to the first example can be applied to a recording apparatus, a mobile phone, a digital camera or the like that uses such an apparatus or method.

According to the image encoding apparatus and the image encoding method in the above-described first example of the present invention, it is possible to reduce the encoding amount of the encoded data and prevent deterioration of image quality of the decoded image in a case where the encoded data is decoded. Namely, it is possible to achieve a high compression ratio and a better image quality.

Thus, according to the image encoding apparatus and the image encoding method in the first example of the present invention, it is possible to provide a more suitable image encoding technique.

### Second Example

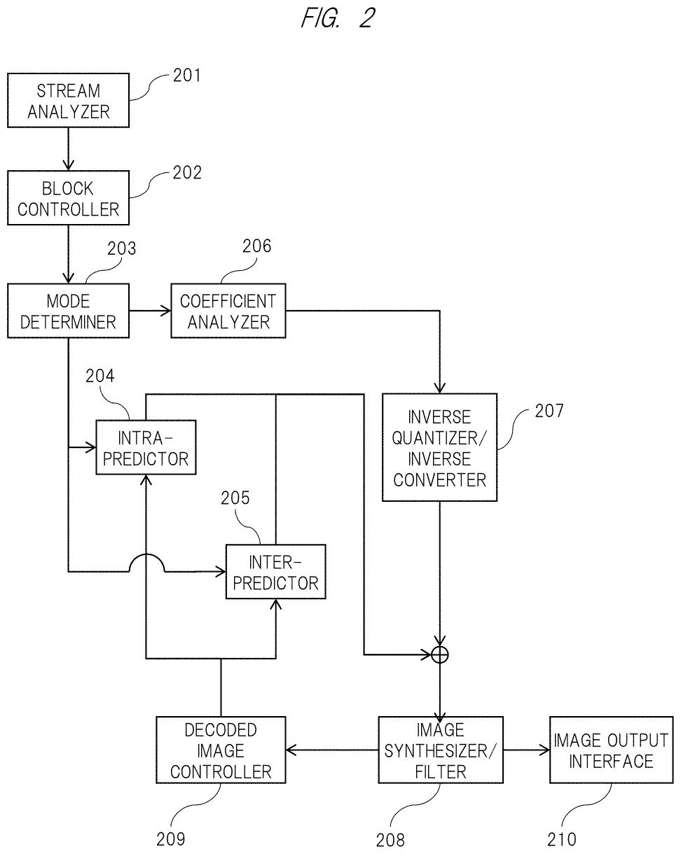

Next, FIG. 2 shows an example of a block diagram of the image decoding apparatus according to a second example of the present invention.

The image decoding apparatus comprises, for example, a stream analyzer 201, a block controller 202, a mode determiner 203, an intra-predictor 204, an inter-predictor 205, a coefficient analyzer 206, an inverse quantizer/inverse converter 207, an image synthesizer/filter 208, a decoded image controller 209, and an image output interface 210.

Hereinafter, an operation of each component of the image decoding apparatus will be described in detail.

Note that the operation of each component of the image decoding apparatus may be, for example, an autonomous operation of each component as described below. In addition, the operation may be achieved by, for example, cooperating with a controller or software stored in a memory.

First, the stream analyzer 201 analyzes an input encoding stream. Here, the stream analyzer 201 also performs a process of extracting data from packets and a process of obtaining information on various headers and flags.

At this time, the encoding stream to be input to the stream analyzer 201 is, for example, the encoding stream generated by the image encoding apparatus and the image encoding method according to the first example. Descriptions of the method of generating the stream is omitted as it is described in the first example. The stream may be an encoding stream read from a data recording medium described in a third example. A recording method thereof will be described below.

Next, the block controller 202 controls processing of the block according to information on the block division analyzed by the stream analyzer 201. In general, the encoded image is divided into blocks, and each block-to-be-encoded is controlled by a tree structure or the like. In most cases, the blocks are processed in the order of raster scanning, but may be processed in any predetermined order such as in the order of zigzag scanning. Details of the new block division scheme added by the present example will be described below in comparison with the conventional block division method.

Next, for each block-to-be-encoded, the mode determiner 203 discriminates the encoding mode specified by the flag or the like. In a decoding process described below, a process corresponding to the encoding mode from the discrimination result is performed. Hereinafter, the process for each encoding mode will be described.

First, in a case where the encoding mode is intra-encoding, the intra-predictor 204 performs intra-prediction and combining of the predictive images. The intra-prediction mode is as described above in the first example.

In a case where the encoding mode is encoding by inter-prediction, the inter-predictor 205 performs inter-prediction and combining of the predictive images. The inter-prediction mode is as described above in the first example.

On the other hand, the coefficient analyzer 206 analyzes the encoded data of each block-to-be-encoded within the input encoding stream, decodes an entropy encoded data, and outputs the encoded data including the coefficient sequence of the residual component. At this time, a process corresponding to the encoding mode from the discrimination result by the mode determiner 203 is performed.

The inverse quantizer/inverse converter 207 performs the inverse quantization and inverse conversion processes on the encoded data including the coefficient sequence of the residual component, and restores the residual component. The methods of inverse quantization and inverse conversion are as described above. The inverse quantization and inverse conversion may be skipped by specifying the mode.

The image synthesizer/filter 208 combines the residual component restored in the above-described manner and the predictive image output from the intra-predictor 204 or the inter-predictor 205. The combined residual component is further processed by loop filtering or the like, and is output as the decoded image.

The decoded image controller 209 retains the decoded image and controls the image to be referenced for intra-prediction and inter-prediction, mode information, and the like.

The final decoded image is output by the image output interface 210, and the image is decoded.

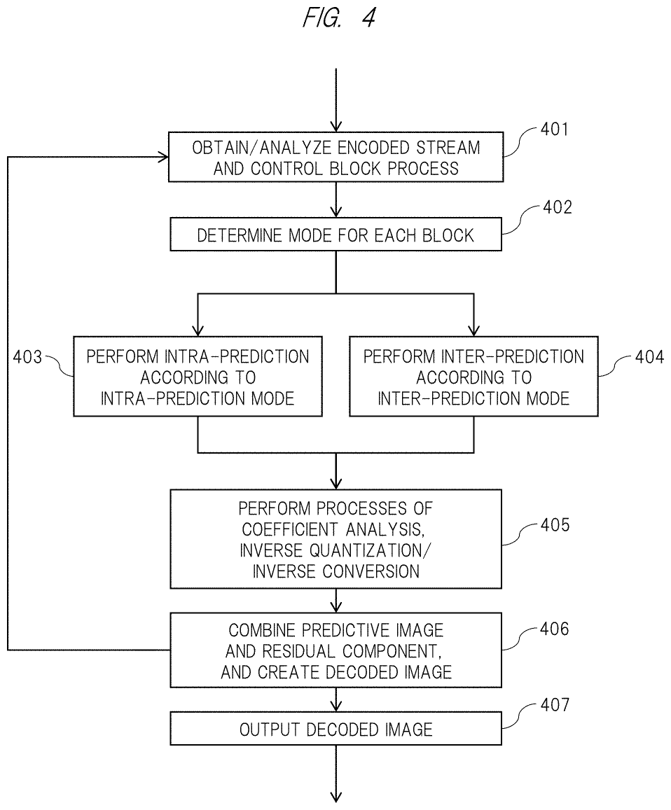

Next, a flow of the image decoding method in the image decoding apparatus according to the second example of the present invention will be described with reference to FIG. 4.

First, in step 401, the encoding stream to be decoded is obtained, and the data is analyzed. In addition, processing of the block is controlled according to the analyzed block division information. The new block division scheme added by the present example is as described in the first example in comparison with the conventional block division method.

Next, in step 402, information on the encoding mode analyzed in step 401 is used to determine the encoding mode for one encoding unit (such as block unit or pixel unit) within the encoded data. Here, if the mode is an intra-encoding mode, the process proceeds to step 403, and if the mode is an inter-encoding mode, the process proceeds to step 404.

In step 403, the predictive image is generated by intra-prediction according to the method specified by the encoding mode. The intra-prediction mode is as described in the first example.

In step 404, the predictive image is generated by inter-prediction according to the method specified by the encoding mode. The inter-prediction mode is as described in the first example.

In step 405, the encoded data of each block-to-be-encoded is analyzed according to the method specified by the encoding mode, the entropy encoded data is decoded, and the encoded data including the coefficient sequence of the residual component is output. Further, the inverse quantization and inverse conversion processes are performed on the encoded data including the coefficient sequence of the residual component, and the residual component is restored. The methods of inverse quantization and inverse conversion are as described above. The inverse quantization and inverse conversion may be skipped by specifying the mode.

In step 406, for each block-to-be-encoded, the restored residual component and the predictive image created by intra-prediction, inter-prediction or the like are combined, and the decoded image is created by further performing a process of loop filtering or the like. The decoded image is created by performing the above-described decoding process in the unit of the block-to-be-encoded on the entire image.

In step 407, the generated decoded image is output and displayed.

Hereinafter, the block division method according to the present example will be described with reference to FIG. 7. Here, a portion of the operation of the block controller 202 will be described in detail.

A block division duplication determiner 701 determines whether or not a situation of the current block division allows the plurality of expression formats, and if the plurality of expression formats are possible, the determiner allows only one expression and prohibits the others, or ranks by priority of processing and selects the division method. Details of the methods of determining duplication and performing ranking by priority are as described in the first example with reference to FIG. 10.

A block division processor 702 performs the block division process according the determination results from the above-described block division duplication determiner 701.

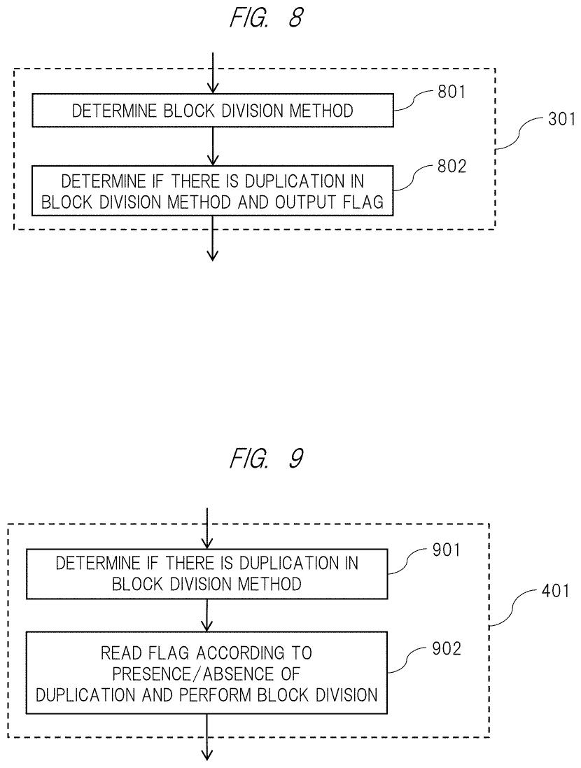

Hereinafter, the block division method according to the present example will be described with reference to FIG. 9.

Here, a portion of step 401 in which block division is performed will be described in detail.

In step 901, it is determined whether or not the situation of the current block division allows the plurality of expression formats, and if the plurality of expression formats are possible, only one expression is allowed and the others are prohibited, or ranking by priority of processing is performed and the division method is selected. Details of the methods of determining duplication and performing ranking by priority are as described above in the first example with reference to FIG.

In step 902, the block division process is performed according to the determined block division method.

Note that, in the present example, in addition to the above, the stream to be decoded may be the encoding stream in which each encoding mode is subdivided and defined by using parameters such as the size of the block used in the encoding mode.

As described above, the decoding process in the present example is performed.

According to the image decoding apparatus and the image decoding method in the above-described second example, it is possible to uniquely define the block division method while achieving various division methods, and thus, it is possible to achieve the image decoding apparatus and the image decoding method with a higher compression efficiency than that of the existing scheme.

In addition, the image decoding apparatus and the image decoding method according to the second example can be applied to a playback apparatus, a mobile phone, a digital camera or the like that uses such an apparatus or method.

According to the image decoding apparatus and the image decoding method in the above-described second example of the present invention, it is possible to decode the encoded data with less encoding amount and higher image quality.

Thus, according to the image decoding apparatus and the image decoding method in the second example of the present invention, it is possible to provide a more suitable image decoding technique.

### Third Example

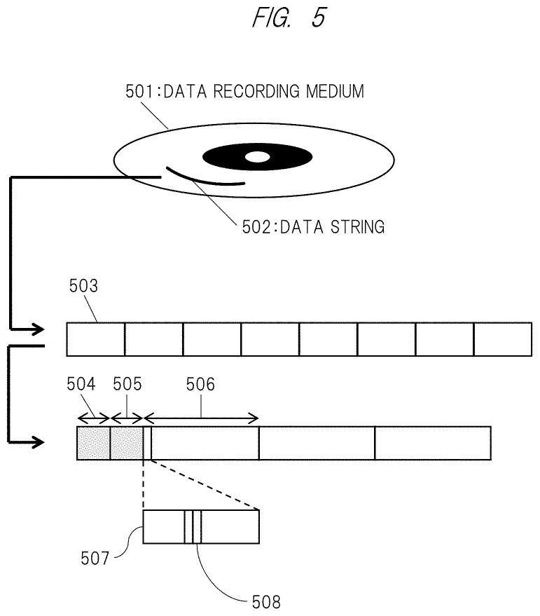

Next, FIG. 5 shows an example of the data recording medium according to the third example of the present invention.

The encoding stream according to the present example of the present invention is the encoding stream generated by the image encoding apparatus or the image encoding method according to the first example. Descriptions of the method of generating the stream is omitted as it is described in the first example.

Here, the encoding stream according to the present example is recorded as, for example, a data string 502 on a data recording medium 501. The data string 502 is recorded as, for example, an encoding stream according to a predetermined syntax.

First, the encoding stream is extracted as a bit string divided into units of a certain size called NAL (Network Abstraction Layer) units 503. The bit string of the NAL unit is read according to a certain rule such as a variable length code, and is converted into an RBSP (Raw Byte Sequence Payload). Data of the RBSP is constituted by information such as a sequence parameter set 504, a picture parameter set 505, a decoding parameter set, a video parameter set and the like, and slice data 506.

Each slice includes, for example, information 507 regarding each block. Information regarding the block includes, for example, a region in which the respective encoding mode for each block is recorded, which is an encoding mode flag 508.

According to the data recording medium in the above-described third example, it is possible to uniquely define the block division method while achieving various division methods, and thus, it is possible to record with a higher compression efficiency than in the existing scheme.

According to the data recording medium in the above-described third example of the present invention, it is possible to reduce the encoding amount and prevent deterioration of the image quality. Namely, it is possible to achieve the data recording medium capable of recording the encoding stream with a high compression ratio and better image quality.

Note that any of the examples described above including each drawing and each method can be combined to constitute an embodiment of the present invention.

According to each of the above-described examples of the present invention, it is possible to reduce the encoding amount and prevent deterioration of the image quality. Namely, it is possible to achieve a high compression ratio and better image quality.

### LIST OF REFERENCE SIGNS

101: image input interface
102: block divider
103: mode controller
104: intra-predictor
105: inter-predictor
106: block processor
107: converter/quantizer
108: inverse quantizer/inverse converter
109: image synthesizer/filter
110: decoded image controller
111: entropy encoder
112: data output interface
201: stream analyzer
202: block controller
203: mode determiner
204: intra-predictor
205: inter-predictor
206: coefficient analyzer
207: inverse quantizer/inverse converter
208: image synthesizer/filter
209: decoded image controller
210: image output interface
601: block division method determiner
602: block division duplication determiner
701: block division duplication determiner
702: block division processor

1. An image encoding apparatus for encoding an input image, comprising:
a block divider configured to combine a plurality of block division methods and perform block division; and
a block division duplication determiner configured such that, if a plurality of description formats are present for the same block division state, the determiner selects one description format among the plurality of description formats,
wherein, as a block division determination method, a division type, a division direction and a division depth are used as a division pattern to select a block division method.

2. The image encoding apparatus according to claim 1,
wherein the division pattern used for determination is a division pattern of a block of interest and of a block above or around the block of interest.

3. An image encoding method of encoding an input image, comprising the steps of:
combining a plurality of block division methods and performing block division; and
if a plurality of description formats are present for the same block division state, selecting one description format among the plurality of description formats,
wherein, as a block division determination method, a division type, a division direction and a division depth are used as a division pattern to select a block division method.

4. An image decoding apparatus for decoding an encoding stream in which an image is encoded, comprising:
a block division duplication determiner configured such that, if a plurality of description formats are present for the same block division state, the determiner selects one description format among the plurality of description formats; and
a block divider configured to combine a plurality of block division methods and perform block division,
wherein, as a block division determination method, a division type, a division direction and a division depth are used as a division pattern to select a block division method.

5. The image decoding apparatus according to claim 4,
wherein the division pattern used for determination is a division pattern of a block of interest and of a block above or around the block of interest.

6. An image decoding method of decoding an encoding stream in which an image is encoded, comprising the steps of:
if a plurality of description formats are present for the same block division state, selecting one description format among the plurality of description formats; and
combining a plurality of block division methods and performing block division,
wherein, as a block division determination method, a division type, a division direction and a division depth are used as a division pattern to select a block division method.
